(19) United States
(12) Patent Application Publication
(10) Pub. No.: US 2008/0235627 A1
(43) Pub. Date: Sep. 25, 2008

(54) NATURAL INTERACTION BY FLOWER-LIKE NAVIGATION

(75) Inventors: Kristian Torning, Denmark (DK); Erik Roser Dibbern, Denmark (DK); Bjarne Schon, Denmark (DK); Hans Gufler, Denmark (DK)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/689,015

(22) Filed: Mar. 21, 2007

(51) Int. Cl. G06F 3/048

(52) U.S. Cl. 715/841; 715/854

(57) ABSTRACT

An intuitive and natural menu selection pattern is provided that allows a user to quickly and easily navigate though a hierarchical menu while mitigating errors associated with making a menu selection. The hierarchical menu can be presented as a flower-like design whereby a main menu item is a central item and lower level menu items are gathered around or near its corresponding upper level menu item. As a menu item is selected, its appearance can change indicating that such item has been selected.

### BACKGROUND

Mobile computing devices are commonly utilized to provide users a means to communicate and stay “connected” while moving from place to place. Technology of such mobile computing devices has advanced to the point where data regarding any desired content is readily available. Such information exchange can occur by a user entering information (e.g., text, visual, audio, and so on) into a display area of a user device and interacting with the device utilizing the display area.

The footprint of computing devices has become smaller and smaller to allow the device to be easily carried and to reduce the weight of the device. This size reduction has resulted in a corresponding reduction in the size of a display area or screen. Thus, as a user attempts to navigate though various directories, applications, files or other functions all the information that the user might need to navigate might not be displayed on the display area. This requires the user to scroll or move through various display pages to achieve the desired result. In addition, performing some functions can be cumbersome and might not allow a user to quickly and easily interact with the device.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with providing natural and interactive menu selection. An aspect relates to receiving a gesture or invocation command for a menu or other action. Items relating to the menu or other actions are presented in a pattern, such as a pattern wherein submenus are expanded outward from a central point. This pattern can be a flower-like pattern wherein the submenus represent flower petals or other patterns that can take advantage of the principles of Fitts' law.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system for facilitating natural interaction with a device.

FIG. 2 illustrates a flower-like design that can provide natural interaction in accordance with the disclosed embodiments.

FIG. 3 illustrates a system that can provide a simple and intuitive interaction with a device.

FIG. 4 illustrates an example of a conventional tap and hold menu.

FIG. 5 illustrates an example of a natural interaction menu in accordance with the embodiments disclosed herein.

FIG. 6 illustrates a method for natural interaction with a device.

FIG. 7 illustrates a block diagram of a computer operable to execute the disclosed embodiments.

FIG. 8 illustrates a schematic block diagram of an exemplary computing environment operable to execute the disclosed embodiments.

### DETAILED DESCRIPTION

Various embodiments are now described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

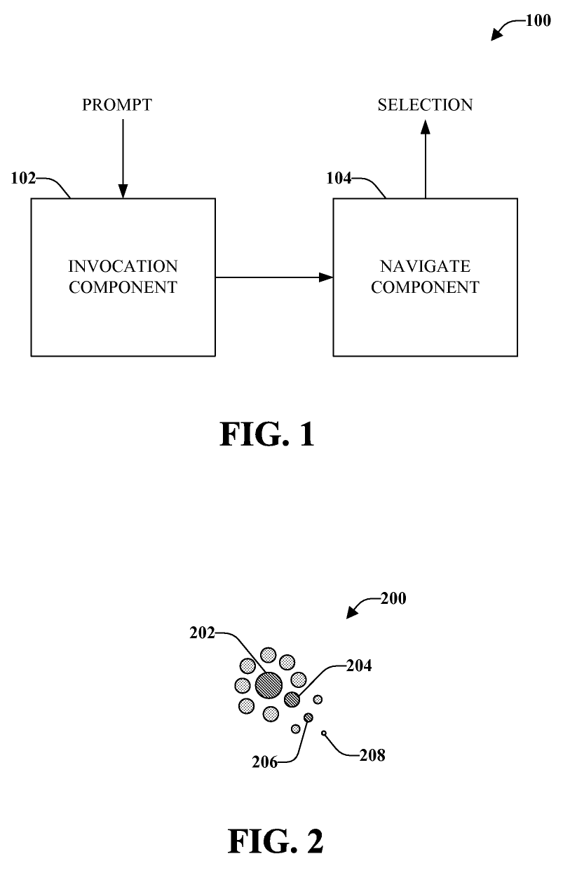

Referring initially to FIG. 1, illustrated is a system 100 for facilitating natural interaction with a device. System 100 can allow a device user to easily and intuitively interact with a device to perform various functions including menu selections and commands. For example, system 100 can provide a user the ability to select a main point or area of a screen and drill outwards in a flower-like visual mode to a final selection point.

In further detail, system 100 includes an invocation component 102 that can be configured to accept a prompt from a user and or entity (e.g., the Internet, another system, a computer, . . . ), hereinafter referred to as user. Such a prompt can be a request to perform a function, open an application, or perform other actions with a device. The invocation component 102 can receive various prompts and can distinguish such prompts from other actions and/or inputs from the user. For example, the prompt might be input on a pre-designated area of a display area. The prompt might be a certain stroke or doodle, such as a swirl or other stoke that distinguishes this stroke from other stokes. Distinguishing the menu invocation stroke from other strokes can mitigate false positives that might occur when a user is simply using the device and performing standard actions (e.g., writing, drawing, and so forth) in a display area of the device.

At substantially the same time as the invocation component 102 receives and recognizes the prompt as a request, such information is communicated to a navigation component 104 that can be configured to assist the user with navigating through various selections or menu items that can be arranged in a hierarchy of selections. For example, such hierarchy of selections might be selections that can alternatively be presented to the user in a drop down menu. The navigation component 104 directs the user starting from a central selection point and progressively directs the user in an outward manner away from the central point, such as in the flower-like design illustrated in FIG. 2. Navigation component 104 can receive an indication (e.g., tapping) that a particular menu items should be executed. Navigation component 104 can change the color of a menu selection when it is chosen (e.g., tapped or other indication) or can change the other non-selected menu selections, such as to give the non-selected menu items a translucent appearance.

In some embodiments, invocation component 102 can allow a user to select (e.g., tap on) multiple menus or selections and navigation component 104 can navigate the user through the multiple selections at substantially the same time. Such multiple selections can include different hierarchies, presented to the user on different areas of the display. For example, a first hierarchy might relate to a file menu and second hierarchy might relate to a table menu, help menu, drawing menu, and other menus.

In addition or alternatively, the multiple selections can include two or more selections within the same hierarchy. For example, if a file hierarchy is chosen a first selection might relate to saving a file and a second selection within the file hierarchy might relate to naming a file. As such, the user can view multiple actions at substantially the same time. In some embodiments, the user can select multiple actions from the same hierarchy at substantially the same time or at different times (e.g., perform a first action and then perform a second selected action).

FIG. 2 illustrates a flower-like design 200 that can provide natural interaction in accordance with the disclosed embodiments. A central point 202 can be a top menu or item in a hierarchy of functions or selections. The central point 202 can be represented as a large circular point or bubble or it can be different shapes and sizes than that illustrated. If the central point 202 is selected, a submenu in the hierarchy can be presented as a circle of bubbles, one of which is labeled 204 (or other shapes), radiating outward from the central point 202. However, as noted, the submenu and items within each menu can be represented by other shapes and/or sizes (e.g., squares, triangles, rectangles, ovals, and so forth).

A user can select an item from the submenu 204, and a next or lower-level submenu 206 can be presented. This lower level submenu 206 can be gathered around (e.g., radiating outward from) the selection 204. That is to say, the items in the lower level submenu 204, 206, 208 can be gathered near or around a higher-level item. As such, the user can be provided a visual representation as to which lower level items correspond with which higher-level items (e.g., it corresponds with the item to which it is closest). A final menu point 208 represents the item or action the user desires.

In some embodiments, the central item 202 and the lower level items can be represented as a color, such as a blue. As each item is selected, the selection can become darker or lighter in color, then the non-selected items. In some embodiments, the selected item becomes a different color, shape or size. In some embodiments, the non-selected items disappear or become translucent to indicate that they were not selected. The user can return to a previous higher-level menu item if a mistake was made or if the user desires to perform a different action than the action selected.

In such a manner, a user is presented with a flower-like design of lower menu items in a hierarchy. This hierarchy can follow the principle of Fitts' Law, which is a model of human movement. Fitts' law states that the time to move from a starting point to a final target is a function of the distance to the target and the size of the target. Applying this principle here indicates that moving a pointing device (e.g., stylus) between two large buttons that are close together is easier than it is to move a pointing device (e.g., stylus) between two small buttons that are far from each other. Thus, the disclosed embodiments can provide interaction with a device that is natural and intuitive and can be faster than traditional methods.

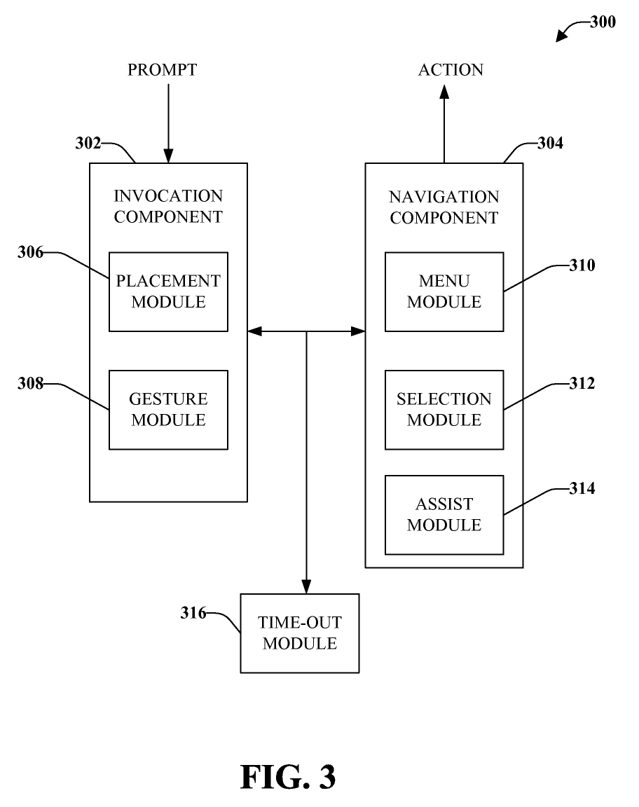

FIG. 3 illustrates a system 300 that can provide a simple and intuitive interaction with a device. Included in system 300 is an invocation component 302 that can be configured to receive a prompt from a user. The prompt can be input with a stylus or finger or other pointing device that is recognizable by system 300. A navigation component 304 can present various menu items, which can assist a user to achieve a desired result, such as by navigating the user though a menu hierarchy. The final menu item selected can provide a user with the desired action (e.g., open a file, display a document, print a file, select from a list of merchandise items, and so on).

Navigation component 302 can include a placement module 306 that can be configured to determine which menu should be presented based on the location on the display that the menu selection prompt was received or input by the user. For example, if the gesture or other action is received in an upper portion of the display area, the selection might be for a file menu. If received in a lower left portion of the display area, the prompt might be for a drawing menu. Such selections based on the placement of the pointing device when the prompt is received or entered can be a system configurable setting, which can be defined by the system 300 and/or the user might selectively configure the menus that are presented when a prompt is received on a particular location on the display screen.

Also included in navigation component 302 can be a gesture module 308 that can be configured to recognize one or more gestures and make a determination whether the gesture is to display a menu selection. A gesture can be a doodle, a swirl or other movement of a pointing device that is intended to invoke a menu selection. The gesture should be different enough from other gestures or movements of the pointing device in order to mitigate the menu being presented when the user is performing a simple operation (e.g., writing with a stylus). For example, a flower-like menu can be invoked when the user draws a spiral gesture and then taps though the different navigation layers (e.g., submenus) to select an item from that layer.

Navigation component 304 can include a menu module 310 that can be configured to present or display a desired menu from a multitude of menus to a user based on a position of a received prompt, a type of gesture received and/or based on other criteria (e.g., voice command to invoke the main menu). There can be different manners by which the selection module 310 presents a particular menu and corresponding information relating to menu items. A user can be provided a setting that can turn a particular menu “on” (e.g., display menu) or “off” (e.g., no longer display the menu). Text help can be provided whereby the menu name or action is presented next to the bubble or over the bubble. Another example is a visual representation of the bubbles and labels, with or without a pointer, next to each bubble.

Also included in navigation component 304 can be a selection module 312 that can assist a user in selecting various menu items. For example, selection module 312 can present a hierarchy of menu items in the form of bubbles or other shapes presented in a flower-like (or other) design. The menu items can be presented as a series of bubbles that become smaller in size as lower level menus are invoked An assist module 314 can be configured to provide various information to assist in selection of one or more menu items. For example, assist module 314 can present information relating to the function of a (e.g., open picture) particular bubble.

In some embodiments, a time-out module 316 is provided that can be configured to interact with invocation component 302 and/or navigation component 304. Time-out module 316 can be configured to determine a length of time that it takes a user to make (e.g., tap on) a menu-selection. If a menu selection is not made within a predetermined amount of time (e.g., 10 seconds), the timer times out and the menu selection is cancelled. Time out module 316 can be utilized for situations such as when the user did not desire a menu to be presented and/or if the user no longer wants to perform a menu function. Other techniques can be utilized to cancel the menu selection, such as tapping on a different area of the display, away from the menu items displayed in the flower-like pattern.

For example purposes and not limitation, an individual desires to see a movie but does not know which one to choose. To navigate through all the movies, there can be a picture of an actor or actors. When a particular actor is selected (tapped on), there might be movies in which that actor performs shown outward from the central picture and the user can select a movie from one of these submenu items.

In another example, an individual wants to go to a movie theater to see a particular movie. A picture of the movie (e.g., movie poster) can be tapped on (e.g., selected). A lower level menu might show the theaters that are playing the movie. A next menu can include the times the movie is being shown. A next (lower-level) menu can include whether there are tickets available for that particular showing and a next lower level menu can allow tickets for that movie to be purchased. Thus, the user can tap to the information desired. The system 300 can also be used in large-screen concepts, such as games or other large screen display applications.

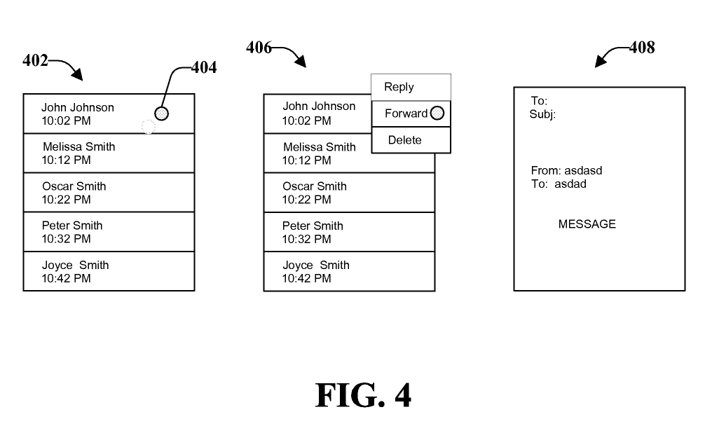

FIG. 4 illustrates an example of a conventional tap and hold menu 400. Some devices include an option for direct interaction by using a pointing device (e.g., stylus, finger) and there are several different ways to navigate within the menu system. However, such interaction techniques might not be intuitive to understand and navigate through. In addition, such interaction techniques may utilize a tap and hold menu that might need additional time to implement a menu selection.

The tap and hold menu 400 illustrated is to send an email. At 402, tapping and holding a list within an email activates a menu. The user taps the screen and holds the stylus at a point, such as 404. This conventional tap and hold menu requires the user to place the stylus down on the display area on the same point 404 and apply some pressure. The stylus must remain on this same point 404 while a timer counts down, which may take about a second or longer, while the timer activates and runs. Progress dots or another visualization technique might be utilized to show the user how long it will take to actually invoke the menu and that the menu is actually being invoked.

At 406, the menu is activated (e.g., pops up) and the user can lift the pen and tap the menu point desired. Thus, a press/tap can activate the menu point selected (e.g., forward). The user can interact and create an email message to send, at 408. However, this approach takes time for the timer and/or progress dots to invoke. In addition, if the user releases pressure, the menu selection disappears and the user has to start over. Thus, the stylus has to be held in the same place for some predefined time to activate the menu and it has limited options due to an embedded menu structure.

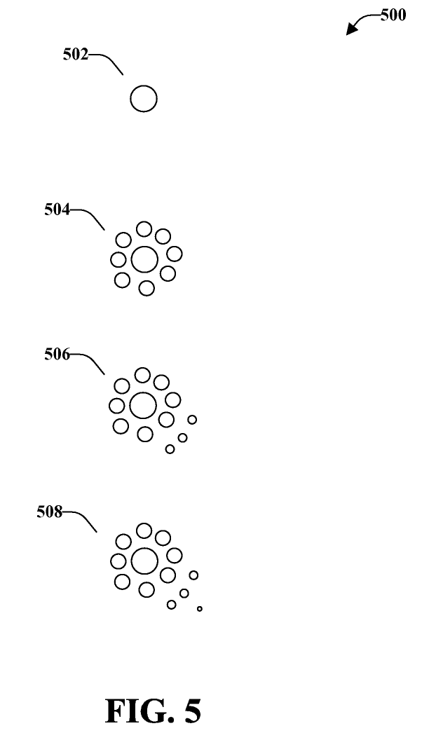

FIG. 5 illustrates an example of a natural interaction menu 500 in accordance with the embodiments disclosed herein. Two examples will be described with reference to the figure. The first example will relate to email and the second example relates to opening a file (e.g., picture, document, spreadsheet, and so forth).

The email example can be performed in three easy taps or steps. The time to flow through the menu selections and achieve the desired result with the disclosed embodiments can represent the same time it would take to perform the first action described with reference to FIG. 4 (e.g., with the tap hold approach). Instead of tap, hold, wait and activate the next menu, with the disclosed embodiments, the user can gesture (e.g., doodle) and then, with a stylus or other pointing device, perform a “tap”, “tap”, “tap” function, which can be performed in a minimal amount of time (e.g., one second). Thus, with the disclosed embodiments, speed of performing menu applications can increase and error rate can potentially decrease.

A single tap on an area of a display screen, such as on a circle or bubble, illustrated at 502, can result in a sub-menu points or items being spread out around the bubble, illustrated at 504. It should be understood that depending on the number of sub-menu items these bubbles 504 do not have to completely surround the main bubble 502.

As a circle or bubble is tapped or selected, it might change color, become darker in color, or provide another visual representation of which circle was selected (e.g., non-selected items might become lighter in color or translucent). In some embodiments, certain menus might be provided with distinct colors. For example, menus relating to files might be a first color so that if that color bubble is presented the user should instinctively know that the menu deals with files. A different menu might be presented to the user in a second color, and so forth.

The first submenu items are illustrated at 504. Tapping a menu point (e.g., circle, bubble) will branch off that particular point to a next submenu, illustrated at 506. Subsequent selections will branch off subsequent submenus, illustrated at 508. It should be understood that there could be fewer or more submenus than that illustrated and described. In addition, there can be fewer or more submenus items than those shown for each submenu.

By way of example and not limitation, for an email application, a first menu 502 might be to “Activate a menu”. Selecting this menu activation displays a submenu 504, wherein one item can be “Reply to email.” Selection of this item can bring up a subsequent submenu 506, wherein one item can be “Reply all”. Upon selection of a last menu item, the selected command can be activated and the user can proceed accordingly. Thus, in this example the user can reply to all or a subset of recipients of an email.

In another example, a menu can be to select a file, document, picture, or other saved or retrievable item. A first menu item 502 can be “Items on Earth”. Selection of the menu item 502 can invoke a lower level menu 504. One of the items in the lower level menu 504 can be “Animals” and selection of this item can bring up a subsequent lower level menu 506. An item in this menu 506 can be selected, such as “Mammals”. At substantially the same time as this item is selected (e.g., tapped), a subsequent lower level can be displayed 508, wherein one of the items can be “Dogs”. Tapping on this subsequent lower level menu 508 can open a dog picture. Although only one menu item is shown at this lowest level 508, there can be more than one, such as “Open a picture of a Collie”, “Open a picture of a Great Dane”, “Open a picture of a Poodle”, and so forth.

In view of the exemplary systems shown and described above, methodologies that may be implemented in accordance with the disclosed subject matter, will be better appreciated with reference to the flow charts are provided. While, for purposes of simplicity of explanation, the methodologies are shown and described as a series of blocks, it is to be understood and appreciated that the disclosed embodiments are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

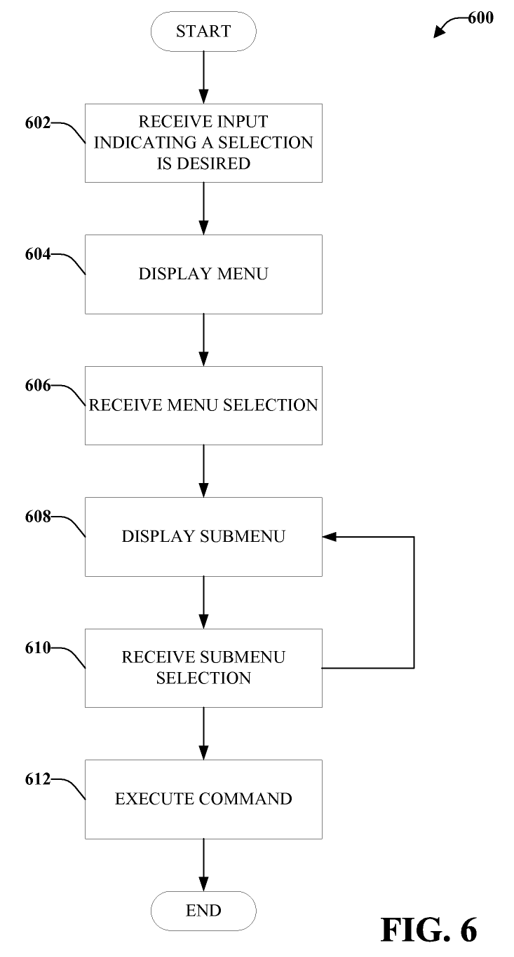

FIG. 6 illustrates a method 600 for natural interaction with a device. At 602, an input is received indicating that a selection, such as a menu or other hierarchical selection is desired. The selection can be input with a pointing device (e.g., stylus, finger, marker, pen, and so forth). Such selection can be based upon a request on a certain portion of the screen and/or a particular recognizable gesture. For example, the input can be distinguished from other actions performed with a stylus or other pointing device to mitigate invoking a menu command when that was not the desired intent of the user.

At 604, a menu and corresponding menu items is displayed, which can be in the form of a flower-like design wherein the main menu or top of the hierarchy is represented in the middle of the flower-like design. Around the middle of the flower-like design, such as in a circle, submenu selections are presented. The submenu selections can be presented in other geometric shapes around or near the center of the flower-like design. For example, a square pattern, triangle pattern, oval pattern, and other patterns can be utilized with the disclosed techniques. In addition, if there are not enough submenu selections to circle the middle of the flower-like design, the submenu selections can be gathered together near the higher level menu within the flower-like design, such as in a semi-circle, quarter-circle, and the like.

At substantially the same time as the submenu item is selected, a subsequent submenu in the hierarchy can be presented, at 608. A selection on this submenu is received at 610. If there are additional submenus, lower in the hierarchy, method 600 can continue at 608 with a next submenu being presented. It should be understood that this act can be recursive and any number of submenu items can be displayed and selected, depending on the depth of the hierarchy.

At 612, the desired command is executed when selection of a lowest level menu item is selected. This command can be the last command or menu selection presented to the user. In some embodiments, there is a time-out period provided, wherein if a selection is not made within a predetermined amount of time (e.g., 10 seconds), the action is cancelled and the menu selections are removed from view. If the timer times-out, to re-execute the command, the user would start over at the main menu by performing the invocation command or gesture.

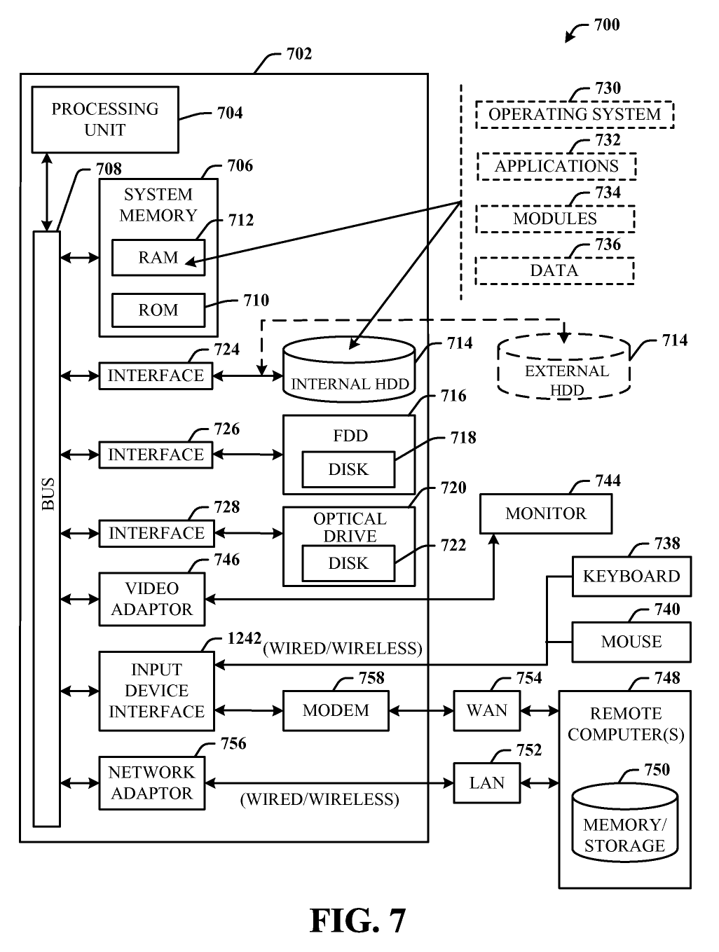

Referring now to FIG. 7, there is illustrated a block diagram of a computer operable to execute the disclosed architecture. In order to provide additional context for various aspects disclosed herein, FIG. 7 and the following discussion are intended to provide a brief, general description of a suitable computing environment 700 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the various embodiments can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 through an interface, such as a video adapter 746. In addition to the monitor 744, a computer typically includes other peripheral output devices (not shown), such as speakers, printers, etc.

The computer 702 may operate in a networked environment using logical connections through wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adaptor 756 may facilitate wired or wireless communication to the LAN 752, which may also include a wireless access point disposed thereon for communicating with the wireless adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 through the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

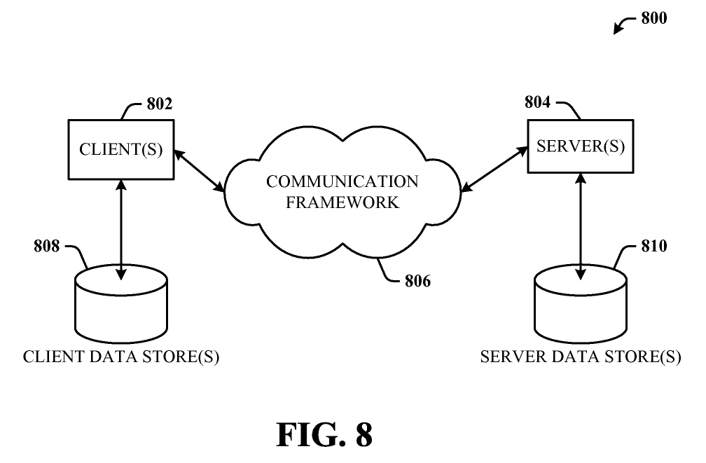

Referring now to FIG. 8, there is illustrated a schematic block diagram of an exemplary computing environment 800 in accordance with the various embodiments. The system 800 includes one or more client(s) 802. The client(s) 802 can be hardware and/or software (e.g., threads, processes, computing devices). The client(s) 802 can house cookie(s) and/or associated contextual information by employing the various embodiments, for example.

The system 800 also includes one or more server(s) 804. The server(s) 804 can also be hardware and/or software (e.g., threads, processes, computing devices). The servers 804 can house threads to perform transformations by employing the various embodiments, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated through a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

What is claimed is:

1. A system for facilitating natural interaction with a device, comprising:
an invocation component that accepts a prompt for a menu; and
a navigation component that provides navigation through a hierarchy of menu selections arranged in a flower-like design.

2. The system of claim 1, the navigation component directs navigation from a central selection point and progressively in an outward manner away from the central point.

3. The system of claim 1, the menu selections are presented as a series of bubbles that become smaller in size as lower level menus are invoked.

4. The system of claim 1, the navigation component changes at least one of a color or a size of at least one menu selection when the at least one menu selection is chosen.

5. The system of claim 1, when at least one menu selection is chosen, the navigation component changes at least a second menu selection to a transparent appearance.

6. The system of claim 1, further comprising a gesture module that distinguishes the accepted prompt from other user actions to mitigate false positives.

7. The system of claim 1, further comprising a selection module that displays information corresponding to each menu selection.

8. The system of claim 8, each menu selection is presented with text information.

9. The system of claim 1, further comprising a placement module that determines which menu from a multitude of menus to display based on an input location of the accepted prompt.

10. The system of claim 9, the placement module makes the input location determination based on a system configurable setting.

11. The system of claim 1, further comprising a time-out module that cancels the menu prompt if a selection is not made within a predetermined amount of time.

12. The system of claim 1, the invocation component accepts multiple menus selections and the navigation component navigates a user through the multiple selections at substantially the same time.

13. A method for natural interaction with a device, comprising:
receiving a menu selection input;
displaying a hierarchical menu that includes a plurality of menu items in a flower-like design;
receiving a selection for at least one menu item from the plurality of menu items; and
executing a command identified by the at least one menu item.

14. The method of claim 13, receiving a menu selection input further comprises distinguishing the menu selection input from other gestures.

15. The method of claim 13, displaying a hierarchical menu further comprises presenting a lower level menu item adjacent a higher level menu item.

16. The method of claim 13, executing a command further comprising receiving a selection for a lowest level menu item.

17. The method of claim 13, further comprising canceling the menu selection input if a subsequent input is not received within a predetermined amount of time.

18. A computer executable system that provides a natural and intuitive menu selection through a hierarchical design, comprising:
means for receiving a menu selection invocation gesture;
means for presenting a plurality of menu items in a hierarchical manner based on the received invocation gesture; and
means for receiving an indication that a particular menu item should be executed.

19. The system of claim 18, further comprising means for providing a visual representation of a selected menu item.

20. The system of claim 18, further comprising presenting the plurality of menu items in a flower-like pattern.
